(19) United States
(12) Patent Application Publication
(10) Pub. No.: US 2017/0055490 A1
(43) Pub. Date: Mar. 2, 2017

(54) Tree-Go-Round

(71) Applicant: Matthew W. Bourdon, Roseville, MI (US)

(72) Inventor: Matthew W. Bourdon, Roseville, MI (US)

(21) Appl. No.: 14/833,189

(22) Filed: Aug. 24, 2015

(51) Int. Cl. A01K 1/04

(52) U.S. Cl. CPC A01K 1/04

(57) ABSTRACT

A locking leash device comprising the four main elements: the guide, the leash shuttle, the brackets, and the locking mechanics. A locking leash device is used to secure a pet animal, such as dog, to stationary objects, such as a pole, small tree, etc., and prevents the pet from tangling a leash about the point of attachment and/or wrapping up in the tree or pole they are tied off to, giving customers a tangle free experience with their dogs. A locking leash device is a portable, convenient to use, simple, lightweight, weather and rust resistant device with interchangeable and replaceable parts that are easy to assemble and remove and made of a resilient material, so as to minimize stress on the dog. It is an environment friendly locking leash device that does not damage any part of the tree, and can be used in many different areas, such as campgrounds and parks.

### CROSS REFERENCE TO RELATED APPLICATION

Not Applicable

### FEDERALLY SPONSORED RESEARCH AND DEVELOPMENT

Not Applicable

### MICROFICHE APPENDIX

Not Applicable

### BACKGROUND OF THE INVENTION

(1) Field of Invention

The present invention generally relates to pet leash devices. More particularly, the present invention relates to a retractable locking leash device that is used to secure a pet animal, such as a dog, to stationary objects, such as a pole, small tree, etc., and prevents the pet from tangling the leash about the point of attachment of the animal leash device.

(2) Background of Invention

Presently, pet owners have to tie a pet leash around an object, or slip the leash into a loop and tie the leash to secure a pet animal to stationary objects, when the pet owners want to tie and leave their pet temporarily for a short period to avoid the theft or escape of the animal. The leash tied in this manner can be easily untied during the pulling of the leash by pet animals, thereby generating the loss, theft or injury to the pet. Moreover the currently available standard leashes or retractable leash devices do not have a unique hinged boundary for opening and closing around objects. The currently available method for tying the pet animals is time consuming and potentially dangerous.

Moreover, such leash devices do not restrain the movement of the pets around the stationary objects to which they are being tied. This results in them wrapping themselves around the object.

U.S. Pat. No. 7,650,673 discloses an adjustable rope tie device for use in connection with horses, dogs, boats, tree trimmings, and other applications where the object or animal tied may need an additional length of rope after being secured.

U.S. Pat. No. 8,327,808 provides a dog leash that is capable of performing multiple functions, including use as a standard lead.

U.S. Pat. No. 7,040,257 discloses a retractable leash device that has a momentary unidirectional lock that is operated to prevent the rotation of the reel in a release direction but to permit the rotation of the reel in a retract direction.

U.S. Pat. No. 6,532,903 discloses a locking leash and collar system that has a pet securing region provided with two separated portions that are locked together or released from one another to permit the locking and the releasing of the pet.

U.S. Pat. No. 6,276,305 discloses a compact dog leash that has a leash attached to the bottom of a pouch and formed with several fold sections that are joined together by fold hinges so that the folded sections and hinges are adapted to permit the expansion and the contraction of the leash.

U.S. Pat. No. 6,095,094 discloses a pet lock collar leash that has an ergonomically designed leash handle to lock a loop of the leash around a fixture.

U.S. Pat. No. 5,890,456 discloses a retractable animal leash device that has a handle coupled to a housing in which a retractable elongated flexible leash is stored inside so that the free end of the leash is attached to an animal.

None of the abovementioned prior art devices provide an easy, efficient, and safe system for attaching a leash around stationary objects, such as poles, small trees, etc., and also prevents pets from wrapping themselves around the pole, small tree, etc. while tied up with a leash.

Accordingly, a need remains for a locking leash device to tie a pet around a pole, tree, or similar stationary objects.

As such, it may be appreciated that there continues to be a need for a new and improved locking leash device, as set forth by the present invention, that addresses the problems of ease of use as well as effectiveness in construction in providing the leash device for use in conjunction with pets. In this respect, the present invention substantially fulfills this need.

### BRIEF SUMMARY OF THE INVENTION

In view of the foregoing disadvantages inherent in the known types of pet leash devices now present in the prior art, the present invention provides an improved locking leash device, wherein the same provides a system for attaching the leash around stationary objects, and use of process of various components employed in the procedure. As such, the general purpose of the present invention, which will be described subsequently in greater detail, is to provide a new and improved locking leash device that has all the advantages of the prior art, and none of the disadvantages.

Accordingly, it is a primary objective of the present invention to provide a retractable locking leash device used to secure a pet animal, such as a dog, to stationary objects, such as a pole, small tree, etc.

In another aspect, the present invention provides a locking leash device that prevents the pet from tangling a leash around the point of attachment of the animal leash device.

Another objective of this invention is to provide a locking pet leash with a hinged component to enable a pet owner to tie and secure the pet animal around a stationary object easily, safely, and efficiently.

Yet another objective of this invention is to prevent the loss or theft of a pet animal when the pet animal is temporarily secured.

Additionally, this invention provides a locking dog leash that is made of a resilient material, so as to minimize stress on the dog.

A further aspect of the present invention provides a locking leash device that is portable, convenient to use, simple, and lightweight. The present invention provides a weather and rust resistant device with interchangeable and replaceable parts that are easy to assemble and remove.

In another aspect, the present invention provides an environment friendly locking leash device that does not damage any part of the tree, and can be used in many different areas, such as campgrounds and parks.

It is still another objective of the present invention to provide a new and improved locking leash device that may be easily and efficiently manufactured and marketed.

It is a further objective of the present invention to provide a new and improved locking leash device that is of a durable and reliable construction.

Other aspects of the present invention will become apparent, from time to time, throughout the specification, as hereinafter related.

In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting.

These, together with other objectives of the invention and the various features of novelty that characterize the invention, are pointed out with particularity in the disclosure. For a better understanding of the invention, its operating advantages, and the specific objectives attained by its uses, reference should be had to the accompanying drawings and descriptive matter, in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention and is, therefore, not to be considered limiting of its scope. The invention will be described and explained with additional specificity and detail through the use of the accompanying drawing, in which:

FIG. 1 is a perspective view of the locking leash device.

FIG. 2 is a perspective view of the half guide of the locking leash device.

FIG. 3 is a perspective view of the bracket.

FIG. 4 is an inner view of the leash shuttle showing the locking mechanics.

FIG. 5a is a perspective view of the dual dog leash end bolt.

FIG. 5b is a perspective view of the handle hardware of the locking leash device.

FIG. 5c is a perspective view of the solo leash handle end bolt.

FIG. 6a is a profile view of the upgraded TGR shuttle.

FIG. 6b is a top view of the fully assembled components of FIG. 6a.

### DETAILED DESCRIPTION OF THE INVENTION

Various aspects of the illustrative embodiments will be described using the terms commonly employed by those skilled in the art to convey the substance of their work to others skilled in the art. However, it will be apparent to those skilled in the art that the present invention may be practiced with only some of the described aspects. For purposes of explanation, specific numbers, materials, and configurations are set forth in order to provide a thorough understanding of the illustrative embodiments. However, it will be apparent to one skilled in the art that the present invention may be practiced without the specific details. In other instances, well-known features are omitted or simplified in order to not obscure the illustrative embodiments.

In some preferred embodiments, the present invention provides a locking leash device that is utilized to tie a pet animal, such as a dog, to a stationary object and thereby prevents the dog from wrapping itself around the tree. The locking leash device, used to secure the dog to stationary objects, such as a pole, small tree, etc., includes a hinged component to enable a pet owner to tie and secure the pet animal around a stationary object easily, safely, and efficiently. This prevents the pet from tangling the leash about the point of attachment of the animal leash device.

To attain this, the present invention is comprised of a housing that has bracket units, and a circumferential wall guide that extends around the brackets. A leash shuttle is coupled with the housing. The housing has an opening into the interior of the housing, which includes the rubber padding in between. The leash has a free end for attachment to an animal extending through the circumference of the housing. Each of the brackets has a coil spring piston in the interior of the housing.

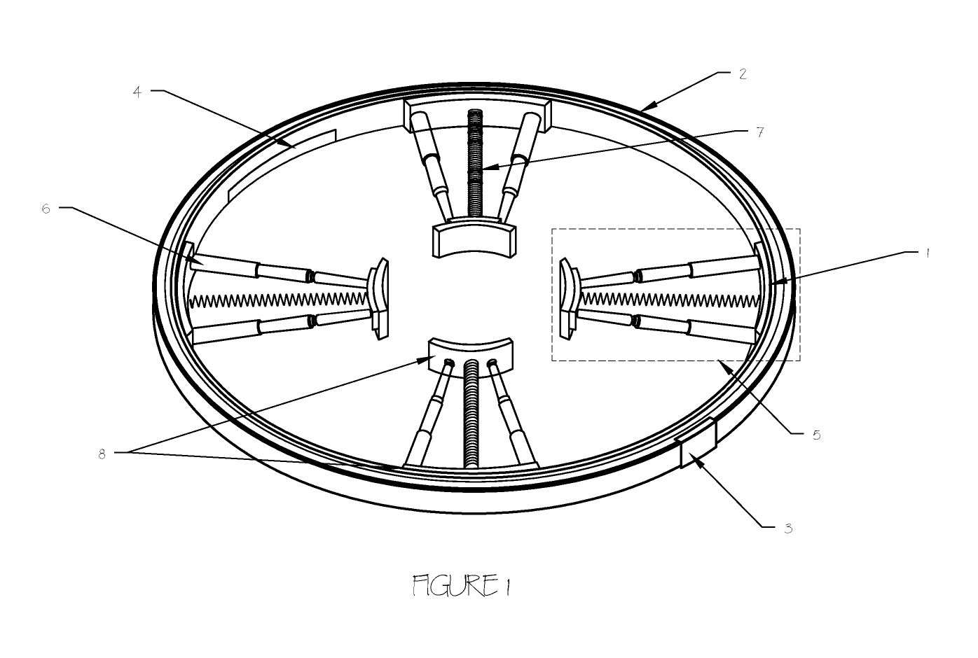

With reference now to the drawings, and in particular to FIGS. 1 to 6 thereof, a new and improved pet leash locking device embodying the principles and concepts of the present invention are described herein.

FIG. 1 illustrates that an embodiment of the pet leash locking device according to this invention is designated generally by the reference character 1. The overall housing assembly of the device includes a generally circular enclosure and a defined guide 2 herein with a leash shuttle 3 defining the outer circumferential area of the guide.

The guide is separable into two halves. Each half is identical design and function, varying only in length if necessary or desired. The two halves of the guide are coupled together through the locking mechanics 4.

Further, the inside circumference of the housing includes four or more brackets 5 (four brackets preferred) and a coil spring piston 6 involving the coil spring 7 in between the two rubber paddings 8, each at both ends.

Therefore, the disclosed device is comprised of four major elements: the guide, the leash shuttle, the brackets, and the locking mechanics. Each of the elements, with their specific design and function, is described below in the respective embodiments.

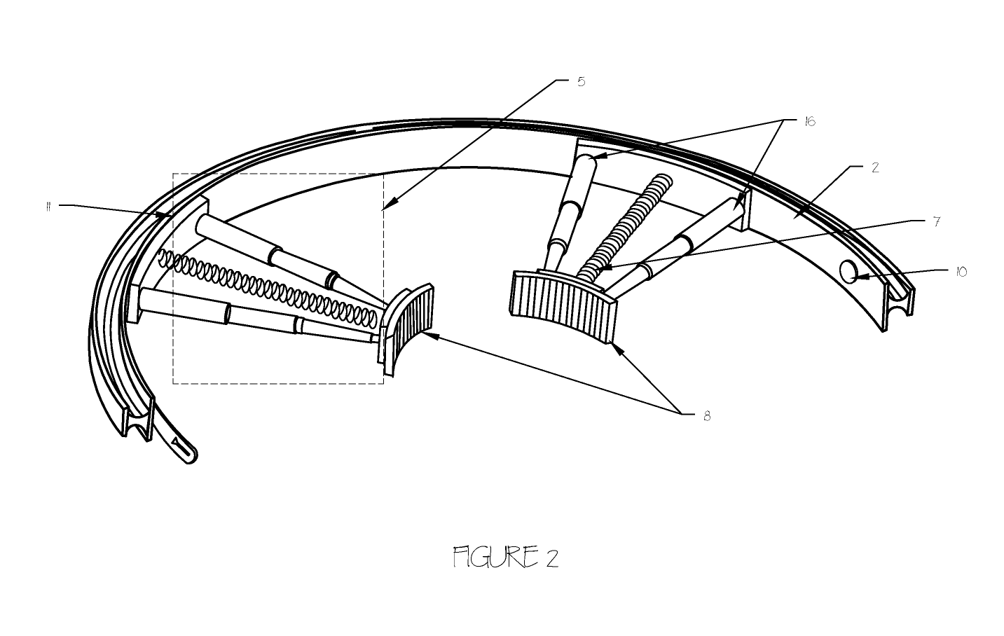

Further embodiment discloses the perspective view of the half guide of the leash locking device, as represented in FIG. 2, which is comprised of the locking mechanics and female 9 and male 10 components at each end of the half guide 2. Each of the half guide involves two brackets 5 that have pistons 6 with coil springs 7 in between the two rubber paddings 8, each at both ends.

The guide is the main component of the pet leash locking device. It is comprised of durable, rustproof materials, such as aluminum, stainless steel, or carbon fiber. The lighter and stronger the material, the better it is. The guide is, as mentioned above two individual pieces each being half of the circumference required to complete the track around the tree and/or pole. These pieces should be symmetrical (as half guide picture shown in FIG. 2).

The guide functions as the track for the leash shuttle, similar to that of a roller coaster or train track. It should be able to withstand at least 300 lbs of resistance, as the device should be outfitted to handle any breed/sized dog and the animals' strength while tugging. The material used should be at least ⅛ inch thick, solid metal/carbon fiber.

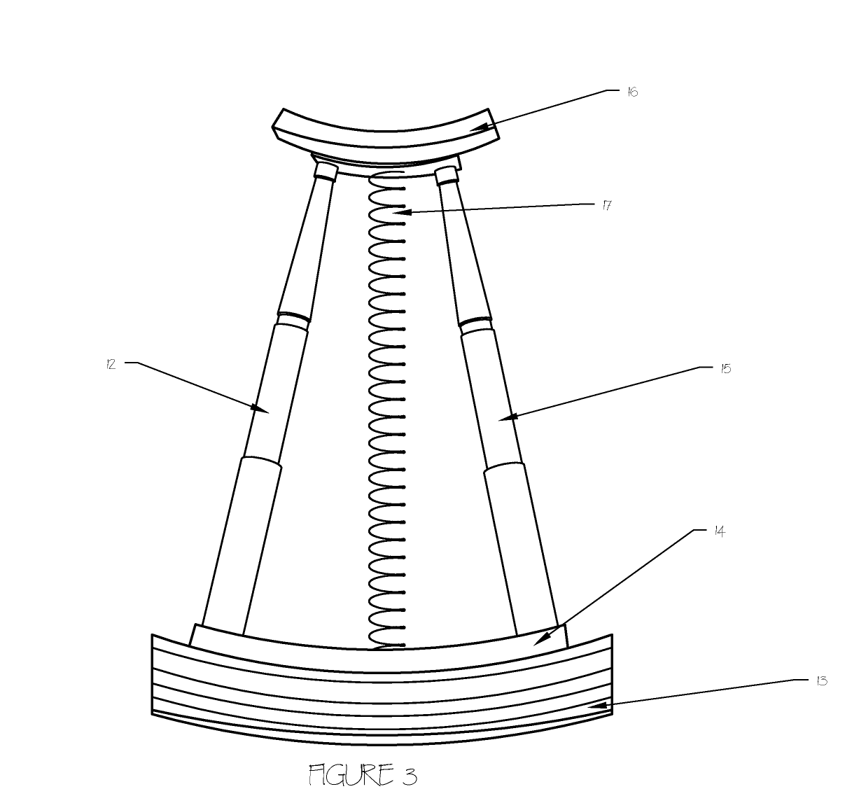

FIG. 3 discloses the components of the bracket 12, wherein the bracket is attached to the inner circumference of the guide 13 and is connected through the base rubber padding 14. The bracket involves the rubber padding at its both ends; base rubber padding at outer end and grooved rubber padding 16 at its inner end. Furthermore, the bracket is comprised of the two coil spring piston 15 surrounding the coil spring 17 at both sides.

The bracket provides enough resistance through springs or air pneumatic/hydraulic pistons . This will help prevent the guide from bending or breaking, as well as to provide more durability. Furhtermore, it provides a little cushion as the dog tugs and pulls to help prevent injury to the dog. It does not provide a sudden jerk of a stop, but, rather, more or less a slow resistant stop if the dog attempts to run after something, or do some like activity(s).

The brackets should be able to be taken off of the guide and replaced easily in the event of damage. After tightening the entire device and properly securing it around the tree or pole, the brackets should provide enough resistance to hold the device snug against the tree/pole at a comfortable height for the owner.

The inside portion of the bracket (the part of the guide 13 that presses against the tree), should be made of grooved rubber 16 to help prevent damage to the tree. These groves should act like teeth in the bark of the tree.

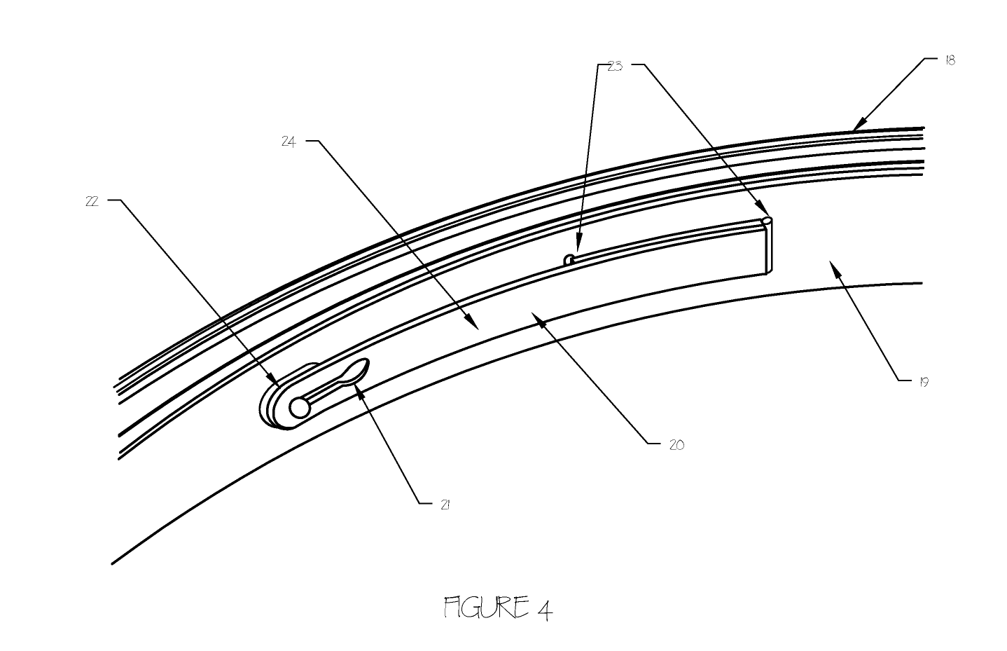

FIG. 4 illustrates that the leash shuttle, 3 as shown (inside view), is present at each end, where the two portions of the half guides 18 and 19 are connected to complete a guide 2. The leash shuttle is also comprised of a lightweight, weather resistant material, such as aluminum. The leash shuttle is the component, where the dog owner attaches the dog's leash to. It acts as a “shuttle” around the guide, thus given its name. While the two halves of the guide are dismantled, slide the leash shuttle onto guide, on the outside ring of the guide prior to installation. The top and bottom lips of the leash shuttle should be outlined with ball bearings, to help prevent resistance as the dog walks around the tree. The shuttle has just enough concave curvature to easily glide around the guide, where the shuttle component should match the curvature of the guide.

In another preferred embodiment, FIG. 4 also represents the locking mechanics 20, which involves the male and female components of the locking mechanics. The female component of locking mechanics is comprised of the ball-pin groove 21, which slides onto the stationary ball-pin 22 of the male locking mechanics. The ball-pin groove is connected on the female locking mechanics via hinges 23. The locking mechanics also involves the handle 24.

The locking mechanics is identical on both guide halves. The locking mechanics, therefore, are adjacent to each other where the male and female ends interact appropriately. As shown in FIG. 4, activated locking mechanic is illustrated that locks the two halves together while the owner is installing it. This not only helps to minimize breaking, but it also provides a stronger bond between the two guide halves with minimal effort.

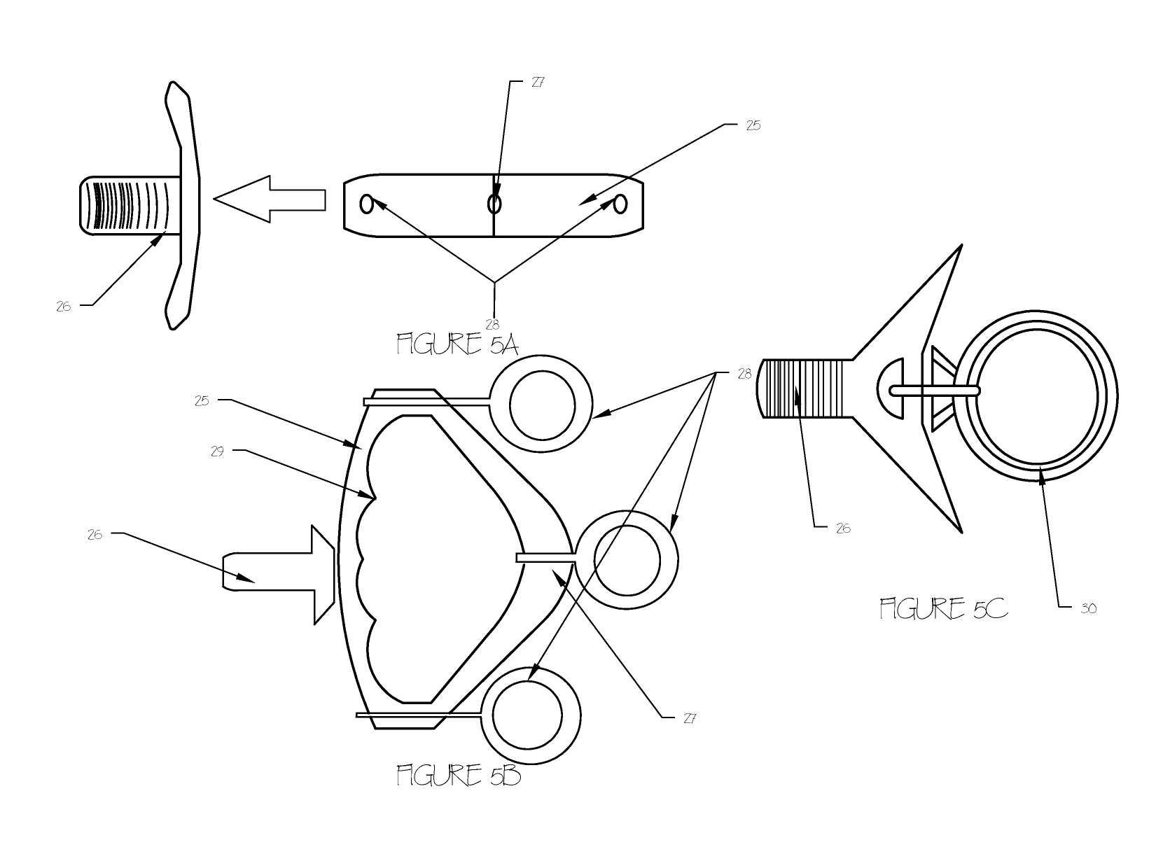

In a further embodiment, FIG. 5a illustrates the front view of the solid cylindrical support bracket for O-rings/clips 25 and the side view of the male butterfly bolt 26. The male butterfly bolt can be tightened down by the hand easily, without the use of hand tools, in the free spinning axis point 27. The support bracket is comprised of the free spinning O-rings/clips 28 at each end. This allows the user to have upto two dogs on the leash device at one time. The O-rings/clips are meant at each end to prevent both dogs from tangling up in each other's leash, where the free spinning allows the dogs to move freely without loosening the male butterfly bolt from the use.

FIG. 5b is a perspective view of the handle hardware of the present inventive leash locking device representing the combined structure of male butterfly bolt 26 attached to the support bracket 25. This provides the handle like structure with a comfortable hand grip 29.

This allows the user to keep their dogs on the leash while removing the dogs from the device, and can also be used to take dogs for a walk without the risk of removing the dog from the device.

Further, as already stated above, the handle like structure is comprised of the three axis points to hold the free spinning O-rings/clips. The middle O-ring is used to tie a single dog (as shown in FIG. 5c) whereas the either side O-rings is utilized to tie two dogs at either end. The leash loop 30 is attached in such a manner so that it should spin freely, preventing the bolt 26 from unscrewing itself from wear and tear.

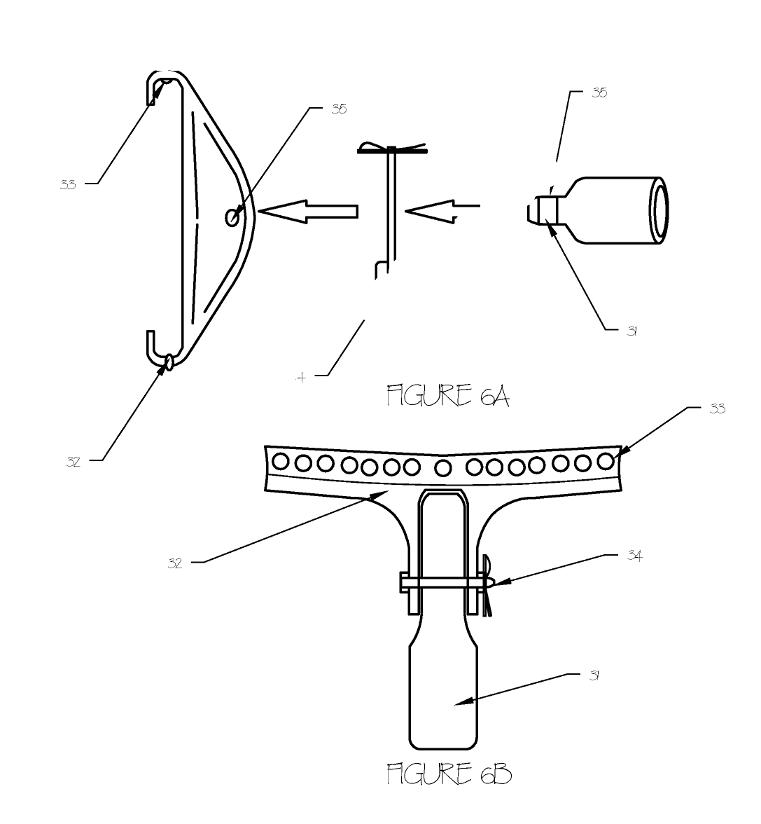

In another embodiment, FIG. 6 represents the attachment of the female threaded socket 31 to the shuttle/support arms 32, comprising the ball bearings 33, with the help of the pin 34, hooked into the pin hole 35. The FIG. 6a represents the de-assembled elements whereas the assembled elements in its top view are represented in FIG. 6b.

In accordance with the invention, instructions made to assemble and utilize the present inventive leash locking device are stated:
i. Locate the structure the user plans to use (Pole, tree, etc.).
ii. Clip the brackets to the guide in the designated areas.
iii. Lay the two halves appropriately on the ground around the structure.
iv. Slide the shuttle onto either side of the guide, it should freely slide around while installing.
v. Secure one side of both halves of the guides using the locking mechanics
vi. Lift the TGR to the appropriate height, and secure the opposite side of the TGR using the locking mechanics.
vii. Adjust the brackets as needed to ensure a secure fit around the structure, give it a little tug to make sure all connections are tight.
viii. Attach the dog's leash to the shuttle bracket clip, attach dog to leash.

The device is easily assembled and easily removed, where the installation process should take less than 5 minutes. The device is durable and is useful in many areas, such as campgrounds, parks, BBQ with friends/family, and even in the user's own back yard.

The leash locking device can be made in various sizes, such as small, medium, large, x-large, and xx-large, with small device having a diameter of roughly 28″, and the xx large having a diameter of roughly 6 feet. The standard size is roughly 36-40 inches in diameter, as this size should adjust to the majority of trees and poles. Each size is able to handle any breed, and should only be restricted to the size of the structure the customer is using.

As may now be appreciated from the above description and reference to the accompanying drawings, the present invention provides a new and improved locking leash device that may be primarily utilized to tie the dogs with the stationary objects (tree, poles, etc.) and prevent dogs from wrapping themselves around the tree or pole they are tied off to, giving customers a tangle free experience with their dogs.

It is to be understood that the above description is intended to be illustrative, and not restrictive. For example, the above-discussed embodiments may be used in combination with each other. Many other embodiments will be apparent to those of skill in the art upon reviewing the above description.

With respect to the above description, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Furthermore, since numerous modifications and changes will readily occur to those skilled in the art, it is not desired to limit the invention to the exact construction and operation shown and described, and, accordingly, all suitable modifications and equivalents may be resorted to, falling within the scope of the invention.

I/we claim:

1. An improved locking leash device to tie dogs to stationary objects, comprised of:
a) guide,
b) leash shuttle attaching the dog's leash with the device;
c) brackets holding sai whole device with the stationary object; and
d) locking mechanics connecting the two half guides together.

2. The improved locking leash device of claim 1 wherein said device forms the outer circumference of said device, involves said brackets in the interior and said leash shuttle in the exterior;

3. The locking leash device of claim 1, wherein said guide is the main component of the pet leash locking device, comprising the two individual pieces each being half of the circumference required to complete the track around the tree and/or pole.

4. The locking leash device of claim 1, wherein said guide is comprised of durable, rustproof materials, such as aluminum, stainless steel, or carbon fiber.

5. The locking leash device of claim 1, wherein said leash shuttle is comprised of a lightweight, weather resistant material, such as aluminum.

6. The locking leash device of claim 1, wherein said bracket is attached towards the inner circumference of said guide, comprises the two coil spring piston surrounding the coil spring at both sides which involves the rubber padding at its both ends.

7. The locking leash device of claim 1, wherein said bracket provides enough resistance by using springs, or air pneumatic/hydraulic pistons, and help prevent said guide from bending, or breaking, as well as provide more durability; and a little cushion as the dog tugs and pulls to help prevent injury to the dog.

8. The locking leash device of claim 1, wherein said locking mechanics involves the male and female components. The female component comprises the ball-pin groove, which slides onto the stationary ball-pin of the male said locking mechanics.

9. The locking leash device of claim 1, wherein said locking mechanics locks the two guide halves together, provides a complete assembled device.

10. The locking leash device of claim 1, wherein said locking mechanics helps to minimize breaking, and provides a stronger bond between the two guide halves, with minimal effort.

11. The locking leash device of claim 1, wherein said locking leash device is utilized to tie the dogs with the stationary objects such as small tree, poles, etc.

12. The locking leash device of claim 1, wherein said locking leash device prevent dogs from wrapping up in the tree or pole they are tied off to, giving customers a tangle free experience with their dogs.

13. The locking leash device of claim 1, wherein said locking leash device involves the three axis points to hold the free spinning O-rings/clips, wherein the middle O-ring is used to tie a single dog whereas the either side O-rings is utilized to tie the two dogs each at either end.

14. The locking leash device of claim 1, wherein said leash loop is attached in such a manner so that it should spin freely, preventing the bolt from unscrewing itself from wear and tear.

15. The locking leash device of claim 1, wherein said locking leash device involves the following steps to install the device:
a. Locate the structure to use (Pole, tree, etc.).
b. Clip said brackets to said guide in the designated areas.
c. Lay the two halves appropriately on the ground around the structure.
d. Slide the shuttle onto either side of said guide, it should freely slide around while installing.
e. Secure one side of both halves of said guides using said locking mechanics
f. Lift the TGR to the appropriate height, and secure the opposite side of the TGR using said locking mechanics.
g. Adjust said brackets as needed to ensure a secure fit around the structure, give it a little tug to make sure all connections are tight.
h. Attach the dog's leash to the shuttle bracket clip, attach dog to leash.

16. The locking leash device of claim 1, wherein said locking leash device is easy to assemble and easy to remove. The installation process requires less than 5 minutes.

17. The locking leash device of claim 1, wherein said device provides a handle, used to take dogs for a walk without the risk of removing the dog from the device.

18. The locking leash device of claim 1, wherein said locking leash device is portable, convenient to use, simple, lightweight, weather and rust resistant, and durable with interchangeable and replaceable parts that are easy to assemble and remove.

19. The locking leash device of claim 1, wherein said locking leash device does not harm any part of the tree, and remain versatile until the tree is ripped off from the ground.

20. The locking leash device of claim 1, wherein said locking leash device involves the following sizes: small, medium, large, x-large, and xx-large, with small device having a diameter of roughly 28″, and the xx large having a diameter of roughly 6 feet.

21. The locking leash device of claim 1, wherein said locking leash device is useful in many areas such as campgrounds, parks, BBQ with friends/family and even in the user's own back yard.
